(19) United States
(12) Patent Application Publication
(10) Pub. No.: US 2019/0346335 A1
(43) Pub. Date: Nov. 14, 2019

(54) BENDING ANGLE SENSORS AND METHODS FOR MANUFACTURING THE SAME

(71) Applicant: Massachusetts Institute of Technology, Cambridge, MA (US)

(72) Inventors: Kamal Youcef-Toumi, Cambridge, MA (US); You Wu, Cambridge, MA (US); Elizabeth Mittmann, Palo Alto, CA (US); Yi Wang, Beijing (CN); Yip Fun Yeung, Cambridge, MA (US)

(21) Appl. No.: 16/408,047

(22) Filed: May 9, 2019

Related U.S. Application Data
(60) Provisional application No. 62/669,137, filed on May 9, 2018.

(51) Int. Cl. G01M 3/28; G01L 1/22; F17D 5/06

(52) U.S. Cl. CPC G01M 3/2815; F17D 5/06; G01L 1/22

(57) ABSTRACT

Bending angle sensors, and methods for manufacturing such bending angle sensors, are provided herein to reduce cost and time to manufacture. Exemplary sensors can include a fabric or other material layer disposed on a surface of a first material layer that contains a sensing element. By using a fabric or other material layer that has stiffness greater than the first material layer, the neutral shear axis of the first material layer can be shifted away from the central longitudinal axis of the first material layer. By shifting the neutral shear axis to one side of the first material layer, the sensor can be manufactured with larger less expensive sensing elements. Alternatively, or additionally, the sensing element can be embedded within the membrane with less precision by eliminating the requirement that the sensing element must be disposed on one side of the central longitudinal axis of the first material layer.

### RELATED APPLICATIONS

This application claims the benefit of U.S. Provisional Patent Application No. 62/669,137, filed on May 9, 2018, the contents of which is incorporated herein by reference in its entirety.

### FIELD

The present disclosure relates to bending angle sensors and methods for manufacturing the same, and more particularly to such sensors and manufacturing methods that allow for less precision during the manufacture process and/or the ability to use larger, low-cost sensing elements. Bending angle sensors can be used across a variety of fields, including but not limited to helping detect leaks in pipes.

### BACKGROUND

Soft material sensors can be useful in a variety of applications due to their flexibility and robustness. One example of a soft material sensor is a bending angle sensor. Some conventional bending angle sensors are implemented as a cantilevered beam that can bend in one or more axial directions (e.g., up or down) in response to an applied force. Such sensors can be configured to determine the direction and magnitude to which the applied force compresses, stretches, or bends the sensor, including the magnitude and direction of a bending angle.

FIG. 1 illustrates a conventional bending angle sensor 10 that includes a membrane 30 having an embedded sensing element 50. The membrane 30 is generally made of a soft rubber or other pliable material that can bend, stretch, or compress when an external force is applied. The sensing element 50 can be configured to measure the strain on the membrane 30 that corresponds to such bending, stretching, or compressing of the membrane.

In some instances, the strain can have opposite polarities about a neutral shear axis A_{N} of the membrane 30. For example, as shown in FIG. 1, when a downward external force F is applied on the cantilevered membrane 30, the strain is generally a positive or tensile strain S⁺ on the side above the neutral shear axis A_{N} and a negative or compressive strain 5⁻ on the opposing side below the neutral shear axis. Conversely, when an upward external force is applied, the strain polarities can be in reverse. The strain along the neutral shear axis A_{N} is approximately zero.

To avoid conflating positive and negative strain measurements across the neutral shear axis A_{N}, the sensing element 50 is typically disposed to one side of the membrane 30 that is either above or below the neutral shear axis A_{N}. As shown in FIG. 1, the neutral shear axis A_{N} of the membrane 30 is generally coaxial with a central longitudinal axis A_{C} of the membrane 30. Thus, the sensing element 50 must have a thickness 50h that is less than one half of the thickness 30h of the membrane 30.

Accordingly, for conventional bending angle sensors having a total thickness in the range of about 10 millimeters or less, the sensing element must have a thickness of about 5 millimeters or less to operate properly. Sensing elements of this size, however, are expensive. Additionally, micrometer-level precision may be required to properly dispose the sensing element within the membrane such that it does not cross the neutral shear axis. Costly manufacturing equipment is generally required to affect such precision.

Therefore, there is a need for bending angle sensors, and methods of manufacturing the same, that can be manufactured in a less costly, less precise, and more efficient manner without sacrificing output accuracy in any meaningful manner.

### SUMMARY

As discussed above, in conventional bending angle sensors, a sensing element is typically disposed on one side of the central longitudinal axis of a flexible membrane to avoid conflating sensor measurements across a coaxially-aligned neutral shear axis. This can require the use of expensive sensing elements that are very thin and require costly manufacturing equipment to properly position them within the sensor membrane.

The present disclosure alleviates those problems, among other benefits, by disposing a stiffer material layer to one side of the membrane, which causes the neutral shear axis to shift away from the central longitudinal axis of the membrane. By shifting the neutral shear axis to one side of the membrane, bending angle sensors can be manufactured with larger less expensive sensing elements. Alternatively, or additionally, by shifting the neutral shear axis to one side of the membrane, a sensing element can be embedded within the membrane with less precision by eliminating the requirement that the sensing element must be disposed on one side of the central longitudinal axis of the sensor membrane.

In one exemplary embodiment, a sensor includes a first material layer, a sensing element embedded in the first material layer, and a fabric layer disposed on a first surface of the first material layer. The first material layer has a first stiffness, and the fabric layer has a second stiffness that is greater than the first stiffness of the first material layer.

The first material layer can have a neutral shear axis that is located between a central axis of the first material layer and a central axis of the fabric layer. The location of the neutral shear axis can depend, for example, on the second stiffness of the fabric layer. In some embodiments, the neutral shear axis of the first material layer can be located at or in close proximity to an interface between the first material layer and the fabric layer. The sensing element can be embedded between the neutral shear axis and a second surface of the first material layer. In some such embodiments, the sensing element can have a thickness that is approximately equal to or more than half of a thickness of the first material layer.

The first material layer can include a variety of materials. For example, the first material layer can include one or more layers of a rubber material. The fabric layer can likewise include a variety of materials. For example, the fabric layer can include at least one of a woven fabric and a knitted fabric.

A ratio of the second stiffness of the fabric layer relative to the first stiffness of the first material layer can be approximately equal to or greater than two. A thickness of the fabric layer can be approximately in the range of about 0.25 millimeters to about 0.75 millimeters. A total thickness of the fabric layer and the first material layer can be about 2.0 millimeters. A thickness of the sensing element can be approximately in the range of about 1.0 millimeters to about 1.5 millimeters.

The sensing element can be configured to detect a strain on the first material layer. In some such embodiments, the sensing element can be configured to detect a bend angle associated with the strain on the first material layer. The sensing element can be an electrically conductive strain gauge. For example, the strain gauge can be a polydimethylsiloxane (PDMS) strain gauge.

Another exemplary embodiment of a sensor includes a first material layer, a sensing element embedded in the first material layer, and a second material layer disposed on a first surface of the first material layer. The first material layer has a first thickness and a first stiffness, and the second material layer has a second thickness and a second stiffness, the second stiffness not being dependent on the second thickness of the second material layer. The second stiffness of the second material layer is greater than the first stiffness of the first material layer.

In some embodiments, the second material layer can include a fabric. The various configurations described above with respect to the first described exemplary embodiment of a sensor can be applicable to this exemplary embodiment of a sensor. Likewise, the various features described below can be incorporated into either exemplary embodiment of a sensor, as well as other embodiments of sensors provided for herein or otherwise derivable from the present disclosure.

One exemplary method of manufacturing a sensor includes manufacturing a first material layer having a sensing element embedded in the layer and disposing a fabric layer on a first surface of the first material layer. The first material layer has a first stiffness, and the fabric layer has a second stiffness. The second stiffness of the fabric layer is greater than the first stiffness of the first material layer.

In some embodiments, the sensing element can have a thickness that is approximately equal to or greater than half a thickness of the first material layer. The first material layer can include a variety of materials. For example, the first material layer can include one or more layers of a rubber material. The fabric layer can likewise include a variety of materials. For example, the fabric layer can include at least one of a woven fabric and a knitted fabric.

As explained above with respect to the second exemplary embodiment of a sensor, the various features provided for herein related to the first and second exemplary embodiments of a sensor described above can be applicable to the exemplary method of manufacturing a sensor, as well as other methods of manufacturing derivable from the present disclosures. Still further, although not explicitly drafted as a claim, a person skilled in the art, in view of the present disclosures, will understand various methods of using a sensor that can be achieved in view of the present disclosures. Such uses include, but at not limited to, use in conjunction with a fluid leak detection system, such as a system used to detect leaks in pipes where a liquid is flowing through the pipes.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a side cross-sectional view of a conventional bending angle sensor as provided for in the prior art;

FIG. 2A is a side cross-sectional view of one exemplary embodiment of a bending angle sensor in accordance with the present disclosure;

FIG. 2B is a perspective view of the bending angle sensor of FIG. 2A;

FIG. 3A is a graph illustrating one example of measured electrical resistances over time in response to a compressive strain on an exemplary electrical resistance strain gauge embedded within a bending angle sensor in accordance with the present disclosures (e.g., the bending angle sensor of FIG. 2A);

FIG. 3B is a graph illustrating one example of measured electrical resistances over time in response to a tensile strain on an exemplary electrical resistance strain gauge embedded within a bending angle sensor in accordance with the present disclosures (e.g., the bending angle sensor of FIG. 2A);

FIG. 4 illustrates one exemplary embodiment of a method of manufacturing a bending angle sensor in accordance with the present disclosures; and

FIG. 5 is a schematic illustration of a side cross-sectional view of one exemplary embodiment of an in-pipe leak detection system including bending angle sensors in accordance with the present disclosures.

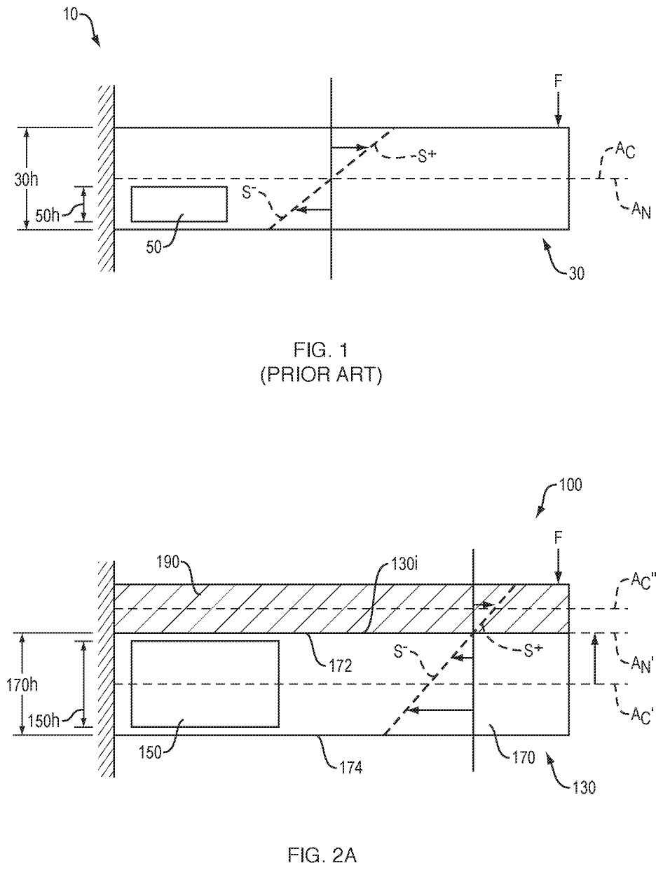

### DETAILED DESCRIPTION

Certain exemplary embodiments will now be described to provide an overall understanding of the principles of the structure, function, manufacture, and use of the sensors and methods disclosed herein. One or more examples of these embodiments are illustrated in the accompanying drawings. Those skilled in the art will understand that the sensors and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

In the present disclosure, like-numbered and/or like-named components of various embodiments generally have similar features when those components are of a similar nature and/or serve a similar purpose, unless stated otherwise. A person skilled in the art, in view of the present disclosure, will understand various instances in which like-numbered components across various figures are akin. Further, although terms such as “first” and “second” are used to describe various aspects of a component, e.g., a first material layer and a second material layer, such use is not indicative that one component comes before the other. Use of terms of this nature may be used to distinguish two similar components or features and/or different sections and/or sides of the same component, and often such first and second components can be used interchangeably. Additionally, to the extent that terms are used in the disclosure to describe a direction, orientation, and/or relative position of the disclosed sensors and components thereof, such terms are not intended to be limiting. For example, a person skilled in the art will recognize that terms of direction, orientation, and/or relative position (e.g., top, bottom, left, right, above, below, etc.) can be used interchangeably depending, at least in part, on the perspective of the operator.

The present disclosure is targeted to improvements in the structure and manufacture of bending angle sensors to reduce cost and time to manufacture. Such sensors can be used in a variety of different contexts, including but not limited in conjunction with detecting leaks in a pipe through which fluid is flowing.

As discussed above, in conventional bending angle sensors, a sensing element is typically disposed on one side of the central longitudinal axis of a flexible membrane to avoid conflating sensor measurements across a coaxially-aligned neutral shear axis. This can require the use of expensive sensing elements that are very thin and require costly manufacturing equipment to properly position them within the sensor membrane. The present disclosure alleviates those problems, among other benefits, by disposing a stiffer material layer to one side of the membrane, which causes the neutral shear axis to shift away from the central longitudinal axis of the membrane. Thus, by shifting the neutral shear axis to one side of the membrane, bending angle sensors can be manufactured with larger, less expensive sensing elements. Alternatively, or additionally, by shifting the neutral shear axis to one side of the membrane, a sensing element can be embedded within the membrane with less precision by eliminating the requirement that the sensing element must be disposed on one side of the central longitudinal axis of the membrane.

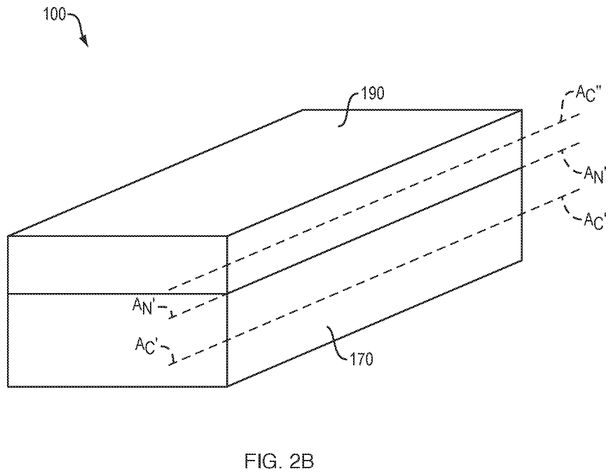

By way of non-limiting example, FIGS. 2A and 2B illustrate one exemplary embodiment of a bending angle sensor 100. As shown, the sensor 100 can include a membrane 130 having a first material layer 170 and a supplemental second material layer 190. A sensing element 150 can be embedded in the first material layer 170. The second material layer 190 can be disposed on a surface of the first material layer 170. In the illustrated embodiment, the second material layer 190 is disposed on an exterior surface 172 of the first material layer 170, e.g., facing the source of an expected force F. Alternatively, in some embodiments, the second material layer 190 can be disposed on an exterior surface 174 of the first material layer 170, e.g., facing away from the source of an expected force F. Although the membrane 130 is shown as having a rectangular shape, the membrane can be configured or adapted to have other geometrical shapes.

To shift the neutral shear axis A_{N}′ of the membrane 130 away from the central longitudinal axis A_{C}′ of the first material layer 170, the second material layer 190 can be configured to have a stiffness that is greater than a stiffness of the first material layer 170. For example, the addition of a stiffer second material layer can shift the neutral shear axis A_{N}′ of the membrane 130 to a location between the central longitudinal axis A_{C}′ of the first material layer 170 and a central longitudinal axis A_{C}″ of the second material layer 190. As shown in FIG. 2B, the neutral shear axis A_{N}′ of the membrane 130 can correspond to a longitudinal plane within the membrane.

The specific location of the neutral shear axis A_{N}′ of the membrane 130 can depend, at least in part, on a ratio of the stiffness of the second material layer 190 relative to the stiffness of the first material layer 170. For example, as shown in FIG. 2A, the neutral shear axis A_{N}′ can be located at or in close proximity to the interface 130i between the first material layer 170 and the second material layer 190 by configuring the second material layer 190 to have a stiffness that is greater than the stiffness of the first material layer 170 by a factor of approximately two (2) or more. In some embodiments, the stiffness of the second material layer 190 can depend on the thickness and constituent material(s) of the layer. In some embodiments, the second material layer 190 can have a stiffness that is not dependent on the thickness of the layer. A person skilled in the art will recognize that the stiffness ratio can be configured to balance the need to adjust the location of the neutral shear axis A_{N}′ with the need to maintain flexibility of the membrane 130 for proper sensitivity and operation of the sensor 100. In some embodiments, the neutral shear axis A_{N}′ can be in close proximity to the interface 130i between the first material layer 170 and the second material layer 190 when the neutral shear axis is located at an approximate distance away from the interface approximately in a range of about 0 millimeters to about one half (50%) of the thickness of the sensor 100.

In some embodiments, Young's modulus can be used as a measure of the stiffness of the first material layer 170 and the second material layer 190. For example, in some embodiments, a ratio of Young's modulus for the second material layer 190 relative to Young's modulus for the first material layer 170 can be approximately equal to two (2). In some embodiments, the ratio can be more than two. In some embodiments, Young's modulus of the first material layer 170 can be approximately in the range between about 0.001 Gigapascal (GPa) to about 0.05 GPa. In some embodiments, Young's modulus of the second material layer 190 can be approximately in the range between about 0.001 Gigapascal (GPa) to about 0.1 GPa. For example, in some certain embodiments, Young's modulus of the first material layer 170 can be approximately 0.005 GPa and Young's modulus of the second material layer 190 can be approximately 0.01 GPa. A person skilled in the art will recognize that other measurements or techniques can be used to determine the stiffness of the respective material layers, such as but not limited to elasticity and Shore hardness.

In some embodiments, the first material layer 170 of the membrane 130 can include a layer of rubber material and the second material layer 190 can include a layer of fabric material, such that the fabric layer has a stiffness greater than a stiffness of the rubber material layer in a longitudinal direction. Exemplary rubber materials for the first material layer 170 can include, without limitation, silicone rubber having Shore A hardness 30. Exemplary fabric materials for the second material layer 190 can include, without limitation, knitted fabrics and woven fabrics, for example.

A person skilled in the art will recognize that while the present disclosure includes references to specific materials for the first and second material layers 170 and 190, a variety of other materials can be used to achieve similar results. For example, other materials for the first material layer 170 that can be used in place of or in addition to rubber material can include polymers, hydrogels, less stiff fabric materials, or any mixture/composite thereof. Other materials for the second material layer 190 that can be used in place of or in addition to a fabric material can include fibers, wires, polymers, hydrogels, higher stiffness rubber materials, or any mixture/composite thereof. In some embodiments, the first material layer 170 can include more than one layer of a rubber material or other suitable material.

By shifting the neutral shear axis A_{N}′ of the membrane 130 towards the stiffer second material layer 190, the strain experienced by the first material layer 170 can be substantially limited to the strain on one side of the neutral shear axis A_{N}′ (i.e., either a compressive strain or a tensile strain). Thus, the sensing element 150 can be positioned within the first material layer 170 or otherwise have a thickness such that the sensing element crosses the central longitudinal axis A_{C}′ of the first material layer 170 without crossing the neutral shear axis A_{N}′ of the membrane 1130.

For example, as shown in the illustrated embodiment, the sensing element 150 can be configured to have a thickness 150h that is greater than one half the thickness 170h of the first material layer 170. Although the sensing element 150, as shown, crosses the central longitudinal axis A_{C}′ of the first material layer 170, the sensing element does not cross the neutral shear axis A_{N}′ of the membrane 130. Thus, the sensor element 150 can be used to measure a strain (e.g., compressive or tensile) on one side of the neutral shear axis A_{N}′, without conflating that measurement with an opposite strain on the other side of the neutral shear axis. Although the present disclosure allows for the sensing element 150 to have a thickness equal to or greater than half of the thickness of the first material layer 170, a person skilled in the art will recognize that the present disclosures can also be used in sensor configurations in which the thickness of the sensing element 150 is less than or equal to half of the thickness of the first material layer.

In some embodiments, where the membrane 130 of the bending angle sensor 100 can have a total thickness 130h of about 2.0 millimeters (mm), the first material layer 170 can have a thickness 170h approximately in the range of about 1.25 mm to about 1.75 mm, the second material layer 190 can have a thickness 190h approximately in the range of about 0.25 mm to about 0.75 mm, and the sensing element 150 can have a thickness 150h approximately in the range of about 1.0 mm to about 1.5 mm. However, a person skilled in the art will recognize that the first material layer 170, the second material layer 190, and the sensing element 150 can be configured to have other thicknesses without departing from the spirit of the present disclosure.

The sensing element 150 can be an electrical resistance strain gauge configured to measure the strain (e.g., compressive or tensile) on one side of the neutral shear axis within the first material layer when an external force is applied that causes the membrane to bend, stretch, or compress. An electrical resistance strain gauge can be implemented using an electrically conductive rubber or other suitable material having a variable electrical resistance that changes in response to the strain on it. Examples of electrical resistance strain gauges can include, without limitation, polydimethylsiloxane (PDMS) and carbon fiber composite electrical resistance strain gauges.

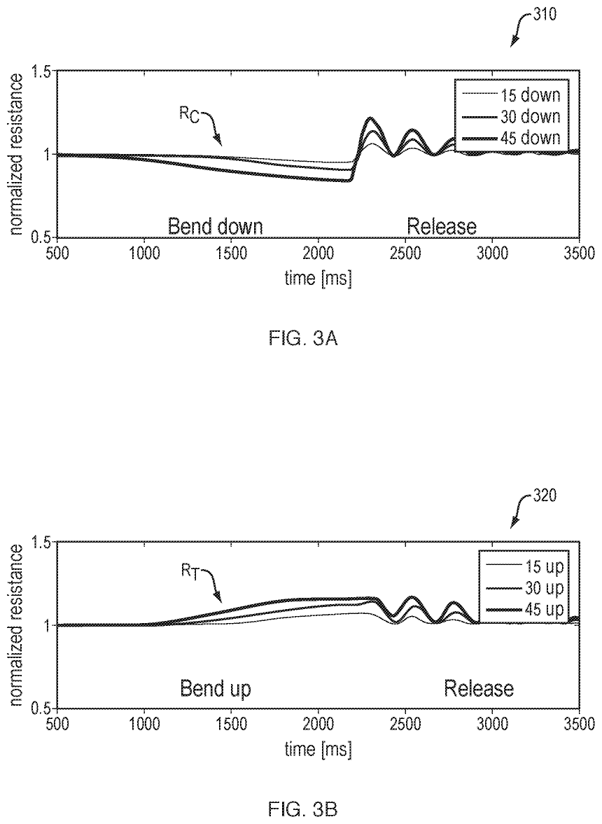

As shown in graph 310 of FIG. 3A, an exemplary strain gauge, such as the sensing element 150, can be configured to have an electrical resistance Rc that decreases in response to a compressive strain, e.g., when the sensing element 150 is disposed within the first material layer 170 and the membrane 130 bends downward. Conversely, as shown in graph 320 of FIG. 3B, an exemplary strain gauge, such as the sensing element 150, can be configured to have an electrical resistance RT that increases in response to a tensile strain, e.g., when the sensing element 150 is disposed within the first material layer 170 and the membrane 130 bends upward. In some embodiments, the sensing element 150 can include other strain gauges or devices capable of measuring strain or stress, including but not limited to linear encoders and force sensitive resistors, for example.

A person skilled in the art will understand how to determine the magnitude and direction of a strain and/or stress on the first material layer 170 of the sensor membrane 130 based on the resistance or other output of the sensing element 150. Additionally, a person skilled in the art will understand how to translate the magnitude and direction of strain and/or stress into a value that represents a corresponding deformation of the sensor membrane 130 in an axial direction relative to the sensing element 150, including but not limited to a stretched length, a compressed length, and/or a bending angle. By shifting the neutral shear axis to one side of the membrane, a bending angle sensor can be manufactured with less precision by eliminating the requirement that the sensing element 150 must be disposed on one side of the central longitudinal axis A_{C}′ of the membrane 130.

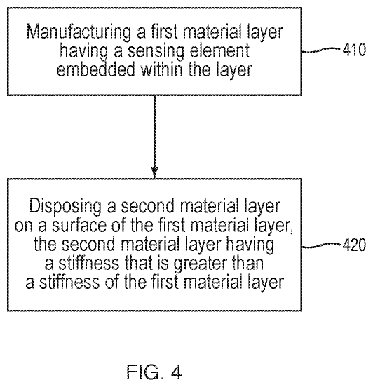

FIG. 4 illustrates one exemplary method 400 of manufacturing a bending angle sensor having a stiff supplementary material layer that causes the neutral shear axis A_{N}′ to shift away from the central longitudinal axis A_{C}′ of the membrane 130. At block 410, the first material layer 170 can be manufactured having a sensing element 150 embedded within the layer. As discussed above, the first material layer 170 can be made of a rubber material. Other materials for the first material layer 170 can include polymers, hydrogels, less stiff fabric materials, or any mixture/composite thereof. The sensing element 150 can be, or include, a strain gauge or other device for measuring strain or stress on the first material layer 170. The sensing element 150 is not required to be disposed on one side of the central longitudinal axis of the first material layer 170. Thus, in some embodiments, the thickness of the sensing element 150 can be greater than one half of the thickness of the first material layer 170. However, the thickness of the sensing element 150 can be less than or equal to or one half of the thickness of the first material layer 170, if desired. Accordingly, manufacture of the first material layer 170, including placement of a sensing element within the layer, can be performed with less precision.

In some embodiments, the first material layer 170 can be manufactured by pouring a liquefied rubber material into a mold of a desired shape. Before the liquefied rubber material cures or hardens, the sensing element 150 can be placed into the mold in a manner that does not require precise placement below the central longitudinal axis of the first material layer 170. Manufacture of the first material layer 170 is complete after the liquefied rubber material hardens and removed from the mold. A person skilled in the art will recognize that other low precision manufacturing processes can be used to manufacture the first material layer 170 having an embedded sensing element 150.

At block 420, a second material layer 190 can be disposed on a surface of the first material layer 170. The second material layer has a stiffness that is greater than a stiffness of the first material layer. As discussed above, the second material layer 190 can be made of a fabric material, such as a knitted fabric or a woven fabric. Other materials for the second material layer 190 can include fibers, wires, polymers, hydrogels, higher stiffness rubber materials, or any mixture/composite thereof. In some embodiments, the second material layer 170 can be disposed on an exterior surface 172 of the first material layer 170, e.g., facing the source of an expected force. Alternatively, the second material layer 190 can be disposed on an exterior surface 174 of the first material layer 170, e.g., facing away from the source of an expected force.

In some embodiments, the second material layer 190 can be disposed on the surface of the first material layer 170 by attaching a piece of fabric or other stiffer material to one side of the first material layer 170. For example, the fabric of the second material layer 190 can be attached to the first material layer 170 in a number of ways known to persons skilled in the art, including, without limitation, bonding, gluing, and stitching.

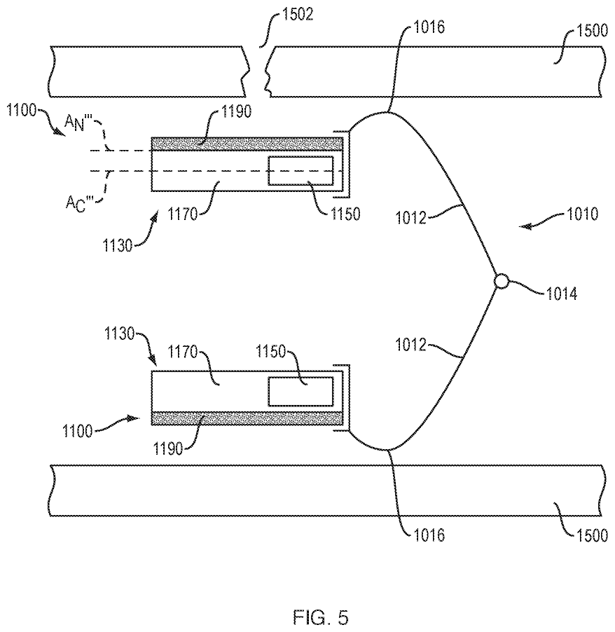

The teachings of the present disclosure can be used in a variety of different contexts and across a variety of industries. By way of non-limiting example, the present disclosures can be applied to manufacturing of bending angle sensors for use in fluid leak detection applications. For example, FIG. 5A and 5B illustrate one exemplary embodiment of an in-pipe leak detection system 1000.

In some embodiments, the in-pipe leak detection system 1000 can include one or more bending angle sensors 1100 attached to a support structure 1010 of the detection system 1000. Although two bending angle sensors 1100 are shown in the illustrated embodiment, more or less than two sensors (e.g., 3, 4, 5 or more sensors) can be included. For example, at least because the system 1000 illustrated in FIG. 5 is a side cross-sectional view, the system 1000 may include two additional sensors 1100 disposed radially equidistant around a central axis of the system 1100 (i.e., the central axis would extend through a common hub 1014, approximately equidistant between the sensor membranes 1130, the hub 1014 and membrane 1130 being discussed in greater detail below). Each of the bending angle sensors 1100 can include a membrane 1130 having a first material layer 1170 and a supplemental second material layer 1190. A sensing element 1150 can be embedded in the first material layer 1170. Except as described below, or as will be readily appreciated by one skilled in the art, the bending angle sensors 1100 can be substantially similar to the bending angle sensor 100 described above with respect to FIGS. 2A-4. A detailed description of the structure and function thereof is thus omitted for the sake of brevity. The bending angle sensors 1100 can include any combination of the features of the bending angle sensor 100 described above and/or other features derivable by a person skilled in the art in view of the present disclosures.

The support structure 1010 can be a spring-loaded, umbrella-like structure that is configured to expand or compress to adapt to changes in diameter and other obstacles or extrusions encountered in a pipe 1500 configured to carry water or other fluid. The support structure 1010 can include support arms or shafts 1012 that extend radially from a common hub 1014. When a fluid flows in the pipe 1500, the fluid flow may push the support structure 1010 such that the radially extending support arms 1012 expand and thereby maintain contact with the inner wall of the pipe 1500 as the system 1000 moves through the pipe. Conversely, when the system 1000 encounters an obstacle (e.g., pipe diameter reduction), the obstacle and/or a fluid flow may push down on one or more the radially extending support arms 1012, thereby compressing the support structure 1010. Each of the bending angle sensors 1100 can be cantilevered from the terminal ends 1016 of the radially extending support arms 1012, thereby positioning each sensor membrane 1130 adjacent to an inner wall of a pipe 1500. Each sensor membrane 1130 can be configured to bend, stretch, or compress in response to a force on the membrane.

The second material layer 1190 of each membrane 1130 can be disposed on an exterior surface 1172 of the first material layer 1170 of the membrane 1130 that faces the inner wall of the pipe 1500. As discussed above with respect to FIGS. 2A-4, the second material layer 1190 can be configured to have a stiffness that is greater than a stiffness of the first material layer 1170 to shift the neutral shear axis A_{N}′″ of the membrane 1130 away from the central longitudinal axis A_{C}′″ of the first material layer 1170. For example, as shown in FIG. 5, the neutral shear axis A_{N}′″ can be located at or in close proximity to the interface between the first material layer 1170 and the second material layer 1190 by configuring the second material layer 1190 to have a stiffness that is greater than the stiffness of the first material layer 1170 by a factor of approximately two (2) or more.

By shifting the neutral shear axis A_{N}′″ of the membrane 1130 towards the stiffer second material layer 1190, the strain experienced by the first material layer 1170 can be substantially limited to the strain on one side of the neutral shear axis A_{N}′″ (i.e., either a compressive strain or a tensile strain). Thus, the sensing element 1150 can be positioned within the first material layer 1170, or otherwise have a thickness, such that the sensing element crosses the central longitudinal axis Ac′″ of the first material layer 1170 without crossing the neutral shear axis A_{N}′″ of the membrane 1130. Accordingly, the sensor element 1150 can be used to measure a strain experienced substantially within the first material layer 1170, without conflating that measurement with an opposite strain on the other side of the neutral shear axis. For example, when the membrane 1130 encounters a leak 1502 in the wall of the pipe 1500, the pressure gradient at the source of the leak can create a suction force that bends the membrane 1130 into contact with the inner wall of the pipe. As the system 1000 continues to move in an axial direction of the fluid flow (e.g., left to right in FIG. 5), the friction force of the inner wall pulls against the membrane 1130, causing strain on the membrane that can be detected by the sensing element 1150.

Further details regarding the structure and operation of an exemplary in-pipe leak detection system suitable for use with a bending angle sensor according to the present disclosures is described in International Patent Application No. PCT/US2017/056890, filed on Oct. 17, 2017, the entire contents of which are incorporated herein by reference. Although the disclosures provided for herein describe a particular application of the exemplary embodiments of a bending angle sensor, namely fluid leak detection, a person skilled in the art will understand how such disclosures can be adapted to manufacture bending angle sensors for use in other potential industries, such as flow sensing, robot motion sensing, and environment sensing. Likewise, while the present disclosure provides for one particular configuration (e.g., size, shape, design, performance characteristics) of a bending angle sensor, a person skilled in the art will recognize other configurations that can be realized in view of the present disclosures.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A sensor, comprising:
a first material layer having a first stiffness;
a sensing element embedded in the first material layer; and
a fabric layer disposed on a first surface of the first material layer, wherein the fabric layer has a second stiffness that is greater than the first stiffness of the first material layer.

2. The sensor of claim 1, wherein the fabric layer comprises at least one of a woven fabric and a knitted fabric.

3. The sensor of claim 1, wherein the first material layer has a neutral shear axis located between a central axis of the first material layer and a central axis of the fabric layer.

4. The sensor of claim 3, wherein the location of the neutral shear axis of the first material layer depends on the second stiffness of the fabric layer.

5. The sensor of claim 3, wherein the neutral shear axis of the first material layer is located at or in close proximity to an interface between the first material layer and the fabric layer.

6. The sensor of claim 3, wherein the sensing element is embedded between the neutral shear axis and a second surface of the first material layer.

7. The sensor of claim 6, wherein the sensing element has a thickness that is approximately equal to or more than half of a thickness of the first material layer.

8. The sensor of claim 1, wherein the first material layer comprises one or more layers of a rubber material.

9. The sensor of claim 1, wherein the sensing element is configured to detect a strain on the first material layer.

10. The sensor of claim 9, wherein the sensing element is configured to detect a bend angle associated with the strain on the first material layer.

11. The sensor of claim 9, wherein the sensing element is an electrically conductive strain gauge.

12. The sensor of claim 11, wherein the electrically conductive strain gauge is a polydimethylsiloxane (PDMS) strain gauge.

13. The sensor of claim 1, wherein a ratio of the second stiffness of the fabric layer relative to the first stiffness of the first material layer is approximately equal to or greater than two.

14. The sensor of claim 1, wherein a thickness of the fabric layer is approximately in the range of about 0.25 mm to about 0.75 mm.

15. The sensor of claim 1, wherein a total thickness of the fabric layer and the first material layer is about 2.0 mm.

16. The sensor of claim 1, wherein a thickness of the sensing element is approximately in the range of about 1.0 mm to about 1.5 mm.

17. A sensor, comprising:
a first material layer having a first thickness and a first stiffness;
a sensing element embedded in the first material layer; and
a second material layer disposed on a first surface of the first material layer, the second material layer having a second thickness and a second stiffness that is not dependent on the second thickness of the second material layer,
wherein the second stiffness of the second material layer is greater than the first stiffness of the first material layer.

18. The sensor of claim 17, wherein the second material layer comprises a fabric.

19. A method of manufacturing a sensor, comprising:
manufacturing a first material layer having a sensing element embedded therein, the first material layer having a first stiffness; and
disposing a fabric layer on a first surface of the first material layer, wherein the fabric layer has a second stiffness,
wherein the second stiffness of the fabric layer is greater than the first stiffness of the first material layer.

20. The method of claim 19, wherein the sensing element has a thickness that is approximately equal to or greater than half a thickness of the first material layer.
